(19) United States
(12) Patent Application Publication
(10) Pub. No.: US 2015/0049640 A1
(43) Pub. Date: Feb. 19, 2015

(54) DATA TRANSMISSION CONTROLLING DEVICE AND METHOD FOR CONTROLLING DATA TRANSMISSION

(71) Applicant: POWER-ALL NETWORKS LIMITED, Shatin (HK)

(72) Inventors: FRANK YEXUN OU, Santa Clara, CA (US); MENG-MING HUANG, Shenzhen (CN); LIU-PING ZHOU, Shenzhen (CN)

(21) Appl. No.: 14/461,451

(22) Filed: Aug. 18, 2014

(30) Foreign Application Priority Data
Aug. 19, 2013 (CN) 2013103610777

(51) Int. Cl. H04L 12/707; H04L 12/861; H04L 12/741; H04L 12/751

(52) U.S. Cl. CPC H04L 45/24; H04L 45/02; H04L 49/9057; H04L 45/74
USPC 370/254; 370/389; 370/394; 370/392

(57) ABSTRACT

A method for controlling data transmission includes: controlling a first data transmission controlling device to transmit a conversation request to a second data transmission controlling device. The method can establish a transmission channel between the two data transmission controlling devices when the second data transmission controlling device accepts the conversation request. The method can establish a plurality of link lines on the transmission channel according to each network accessing path provided by a network connection unit of the first data transmission controlling device. The method can receive data to be transmitted, and divide each data packet of the data to be transmitted to a plurality of sub-packets according to an amount of the link lines of the transmission channel. In additional, the method can transmit the sub-packets of each data packet to a receiver respectively via the plurality of link lines.

### CROSS-REFERENCE TO RELATED APPLICATIONS

This application claims priority to Chinese Patent Application No. 201310361077.7 filed on Aug. 19, 2013 in the China Intellectual Property Office, the contents of which are incorporated by reference herein.

### FIELD

The present disclosure relates to devices, and particularly to a data transmission controlling device and a method thereof.

### BACKGROUND

Electronic devices, such as mobile phones and tablet computers, can communicate with each other or access a network resource, such as videos, via corresponding networks, such as the Internet, a code division multiple access (CDMA) network or other wireless network, or a broadcasting network. Usually, in order to enhance the communication speed or the access speed, virtual private network (VPN) servers are commonly used. Electronic devices can first connect to the VPN server, and then connect to the network via the VPN server.

### BRIEF DESCRIPTION OF THE DRAWINGS

Implementations of the present technology will now be described, by way of example only, with reference to the attached figures.

FIG. 1 is a block diagram of an embodiment of a data transmission controlling device.

FIG. 2 is a block diagram of an embodiment of a data transmission controlling system running in the data transmission controlling device.

FIG. 3 is a flowchart diagram of an embodiment of a method for controlling data transmission.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected.

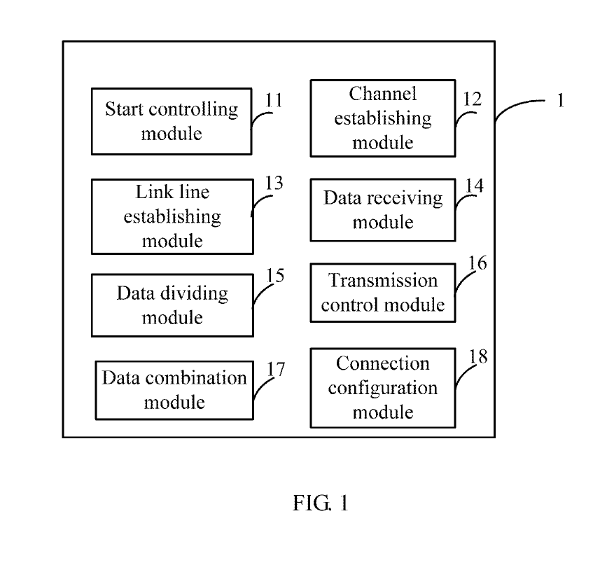

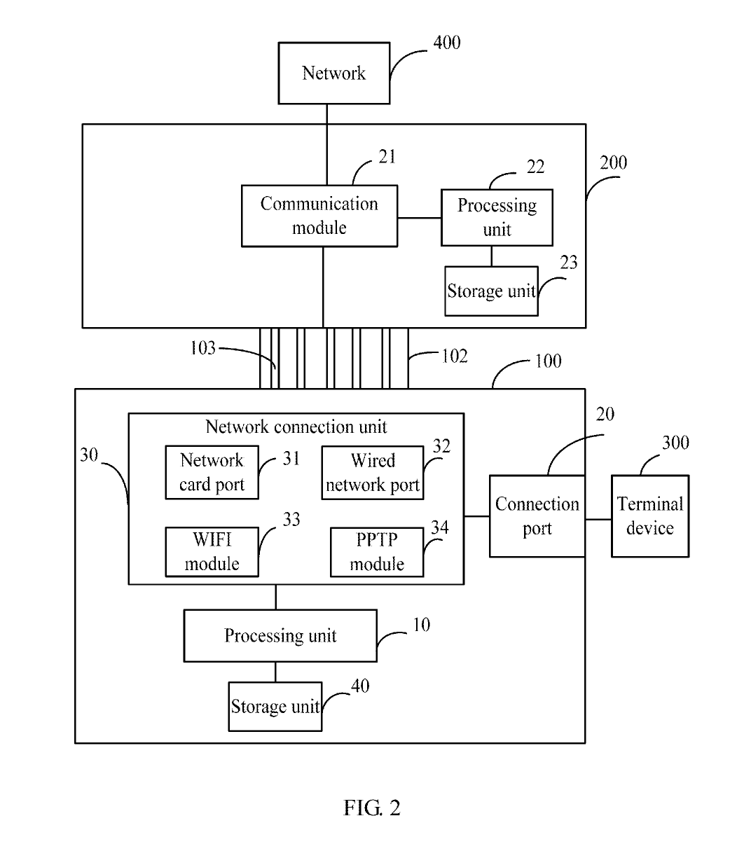

Referring to FIGS. 1 and 2 together, a data transmission controlling system 1 is illustrated. The data transmission controlling system 1 as shown in FIG. 2 is run in a first data transmission controlling device 100 and a second data transmission controlling device 200 as shown in FIG. 1.

The first data transmission controlling device 100 connects to at least one terminal device 300. The second data transmission controlling device 200 connects to the first data transmission controlling device 100 and a network 400. Therefore, the terminal device 300 can connect to the network 400 via the first data transmission controlling device 100 and the second data transmission controlling device 200. In the embodiment, the first data transmission controlling device 100 can be a router, the second data transmission controlling device 200 can be a virtual private network (VPN) server. The terminal device 300 can be a computer, a mobile phone, for example. The network 400 can be the Internet or any other suitable communications, telecommunications, packet-switched, or broadcast network.

The first data transmission controlling device 100 includes a processing unit 10, at least one connection port 20, and a network connection unit 30. The at least one connection port 20 connects to at least one terminal device 300 via wireless mode or wired mode.

The network connection unit 30 generates a number of network accessing path connecting to the second data transmission controlling device 200 in response to a connection and configuration operation of a user. In the embodiment, the network connection unit 30 includes at least one network connection module including but not limited to, a network card port 31, a wired network port 32, a WIFI module 33, and a point to point tunneling protocol (PPTP) module 34.

The network card port 31 connects to network cards, such as a 3rd generation telecommunication (3G) network card, and connect to the second data transmission controlling device 200 via the 3G network card, and then connect to the network 400 via the second data transmission controlling device 200. The wired network port 32 connects to a network cable and connect to the second data transmission controlling device 200 via the network cable, and then connects to the network 400 via the second data transmission controlling device 200. The WIFI module 33 connects to a WIFI network such as a WIFI hotspot or ad-hoc WIFI network and connects to the second data transmission controlling device 200 via the WIFI network, and then connects to the network 400 via the second data transmission controlling device 200. The PPTP module 34 couples to a PPTP server (not shown) and connects to the second data transmission controlling device 200 via the PPTP server, and then connects to the network 400 via the second data transmission controlling device 200.

Each network connection module of the network connection unit 30 can establish at least one network accessing path for connecting to the second data transmission controlling device 200. For example, the network card port 31 can connect to a number of 3G network cards, and each 3G network card provides a network accessing path for connecting to the second data transmission controlling device 200. Each network accessing path can be provided by a corresponding network operator and can have a predetermined bandwidth.

As shown in FIG. 1, the second data transmission controlling device 200 includes a communication module 21 and a processing unit 22. The communication module 21 connects to the network connection unit 30 of the first data transmission controlling device 100 and the network 400. In detail, the communication module 21 can communicate with the network connection unit 30 of the first data transmission controlling device 100 via at least one network accessing path provided by the network connection unit 30. The communication module 21 can be a wired communication module or a wireless communication module. The processing unit 22 controls the communication module 21.

The data transmission controlling system 1 includes a start controlling module 11, a channel establishing module 12, a link line establishing module 13, a data receiving module 14, a data dividing module 15, a transmission control module 16, and a data combination module 17. In the embodiment, the first data transmission controlling device 100 further includes a storage unit 40, the second data transmission controlling device 200 further includes a storage unit 23.

The modules of the data transmission controlling system 1 are a collection of software instructions stored in the storage unit 40 and executed by the processing unit 10 or can be a collection of software instructions stored in the storage unit 23 and executed by the processing unit 22. In one embodiment, the processing units 10, 22 can be central processing units, digital signal processors, systems on a chip, or single chips, for example. In one embodiment, each of the storage units 40, 23 can be an internal storage system, such as a flash memory, a random access memory (RAM) for temporary storage of information, and/or a read-only memory (ROM) for permanent storage of information. Each of the storage units 40, 23 can also be a storage system, such as a hard disk, a storage card, or a data storage medium. In at least one embodiment, each of the storage units 40, 23 can include two or more storage devices such that one storage device is a memory and the other storage device is a hard drive. Additionally, one or more of the storage devices 40, 23 can be located external relative to the data transmission controlling system 1.

The start controlling module 11 controls the first data transmission controlling device 100 to transmit a conversation request to the second data transmission controlling device 200 when receiving a request for starting a conversation aggregation from a user. In the embodiment, the user can login a management interface of the first data transmission controlling device 100 and select a corresponding menu item to generate the request for starting the conversation aggregation. The first data transmission controlling device 100 can transmit the conversation request to the second data transmission controlling device 200 via any of the established network accessing paths.

The channel establishing module 12 establishes a transmission channel 102 between the first data transmission controlling device 100 and the second data transmission controlling device 200 when the second data transmission controlling device 200 accepts the conversation request. In the embodiment, the transmission channel is a Tunnel channel, and is a logical channel.

The link line establishing module 13 establishes a number of link lines 103 on the transmission channel according to each network accessing path of the network connection unit 30 of the first data transmission controlling device 100. In detail, a bandwidth of each link line 103 is the same and equal to a predetermined bandwidth (such as 1 megabit/s (M/s)), the link line establishing module 13 compares the bandwidth of each network accessing path and the predetermined bandwidth, and obtains a ratio of the bandwidth of each network accessing path and the predetermined bandwidth. The link line establishing module 13 then divides the each network accessing path to a number of link lines whose number are equal to the ratio, thus to establish a number of link lines on the transmission channel 102. For example, assuming the predetermined bandwidth is 1 M/s, and there are three network connection path A, B, and C of the network connection unit 30, and the bandwidth of the network connection path A is 5 M/s, the bandwidth of the network connection path B is 2 M/s, and the bandwidth of the network connection path C is 1 M/s. Then, the ratio of the bandwidth of the network accessing path A and the predetermined bandwidth is 5, the ratio of the bandwidth of the network accessing path B and the predetermined bandwidth is 2, and the ratio of the bandwidth of the network accessing path C and the predetermined bandwidth is 1. The link line establishing module 13 then divides the network accessing path A to five link lines 103, divides the network accessing path B to two link lines 103, and divides network accessing path C to one link line 103. Therefore, the link line establishing module 13 establishes eight link lines 103 on the transmission channel 102. In another embodiment, the link line establishing module 13 takes each network accessing path as one link line no matter the bandwidth of network accessing path is greater than the predetermined bandwidth or less than the predetermined bandwidth.

After the transmission channel 102 and the link lines 103 are established, the first data transmission controlling device 100 can transmit data to the second data transmission controlling device 200 via the transmission channel 102 including the link lines 103. Correspondingly, the second data transmission controlling device 200 also can transmit data to the first data transmission controlling device 100 via the transmission channel 102 including the link lines 103.

The data receiving module 14 is used to receives data to be transmitted. In the embodiment, the data to be transmitted can be the data transmitted to the second data transmission controlling device 200 from the first data transmission controlling device 100, and also can be the data transmitted to the first data transmission controlling device 100 from the second data transmission controlling device 200.

The data dividing module 15 divides each data packet of the data to be transmitted to a number of sub-packets according to the amount of the link lines 103 of the transmission channel 102. In the embodiment, an amount of the sub-packets divided from each data packet is equal to the amount of the link lines 103. The number of sub-packets can be less or more than the number of link lines 103.

The transmission control module 16 transmits the sub-packets of each data packet to a receiver, namely the first data transmission controlling device 100 or the second data transmission controlling device 200 respectively via the link lines 103 at the same time. In detail, each link line transmits one sub-packet and the sub-packets of each data packet can be transmitted in parallel via the link lines 103.

The data combination module 17 receives the sub-packets of each data packet, and combines the sub-packets of each data packet to the corresponding data packet in sequence to recover or reconstruct the data to be transmitted.

In detail, when the data dividing module 15 divides one of data packets to the number of sub-packets, the data dividing module 15 adds a unique label to each sub-packets of the data packets, and further adds a corresponding sequence number to one of the sub-packets according to a corresponding sequence that the sub-packets located in the data packet. For example, if one data packet is divided to eighth sub-packets by the data dividing module 15, the data dividing module 15 adds a unique label to all of the eight sub-packets and adds sequence numbers “1”-“8” respectively to a first sub-packet to an eighth sub-packet. Similarly, when another data packet is divided to eighth sub-packets by the data dividing module 15, the data dividing module 15 adds another unique label to all of the eight sub-packets of the another data packet and adds sequence numbers “1”-“8” respectively to a first sub-packet to an eighth sub-packet.

When the data combination module 17 receives the sub-packets, the data combination module 17 determines which sub-packets belong to the same data packet according to the unique label included in the sub-packets. The data combination module 17 then combines the sub-packets of the same data packet to generate the corresponding data packet in sequence according to the sequence number of each sub-packet.

In the embodiment, the data combination module further transmits the recovered data to a target address. In the embodiment, the target address can be an address of a terminal device connected to the first data transmission controlling device 100 or the second data transmission controlling device 200. For example, when the data to be transmitted is transmitted to the second data transmission controlling device 200 from the first data transmission controlling device 100, the target address can be an address of an Internet resource, the data combination module transmits the recovered data to the Internet resource. When the data is transmitted to the first data transmission controlling device 100 from the second data transmission controlling device 200, the target address can be an address of the terminal device 300, the data combination module transmits the recovered data to the terminal device 300.

In another embodiment, the first data transmission controlling device 100 is not limited to the router and the second data transmission controlling device 200 is not limited to the VPN server. The first data transmission controlling device 100 and the second data transmission controlling device 200 can be any type of devices communicate to each other.

In the embodiment, the data transmission controlling system 1 further includes a connection configuration module 18. The connection configuration module 18 controls the network connection unit 30 to establish each network accessing path in response to user operation. For example, the connection configuration module 18 configures and starts up the network card port 31 when the user inserts a network card into the network card port 31. The connection configuration module 18 also can configure and start up the WIFI module 33 or/and the PPTP module 34 in response to operations on a control interface of the first data transmission controlling device 100 after the user logins the control interface of the first data transmission controlling device 100.

Therefore, according to the present disclosure, the data can be transmitted via the number of link lines in parallel, which enhances the transmission speed.

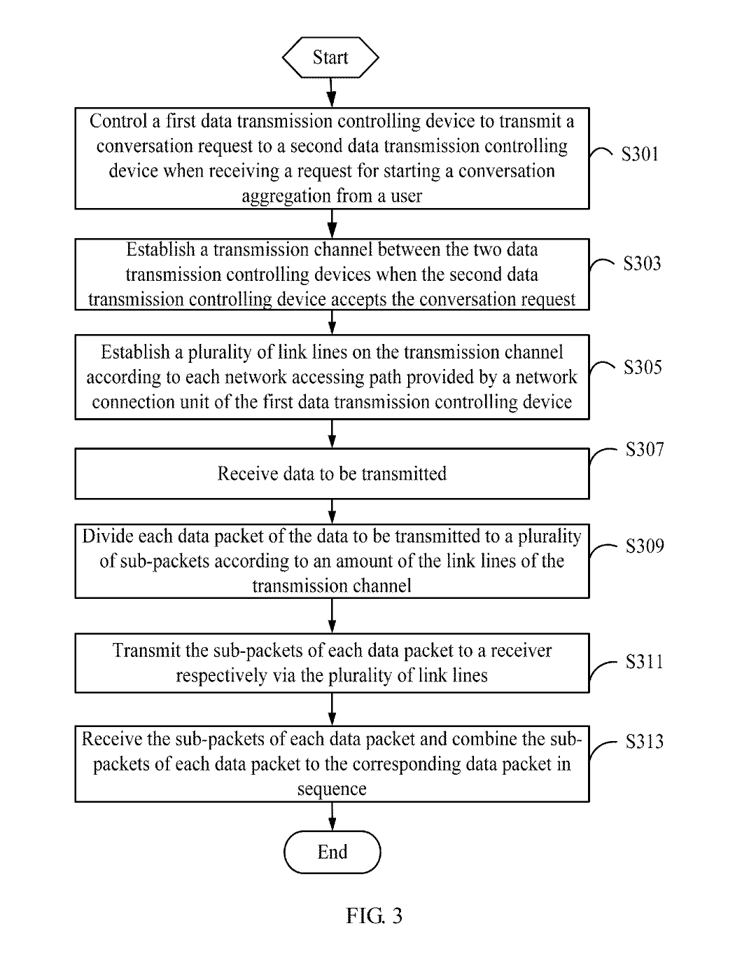

FIG. 3 illustrates a flowchart of a method for controlling data transmission.

In block 301, a start controlling module controls a first data transmission controlling device to transmit a conversation request to a second data transmission controlling device when receiving a request for starting a conversation aggregation from a user via a terminal device connected to the first data transmission controlling device.

In block 303, a channel establishing module establishes a transmission channel between the first data transmission controlling device and the second data transmission controlling device when the second data transmission controlling device accepts the conversation request.

In block 305, a link line establishing module establishes a number of link lines on the transmission channel according to each network accessing path of the network connection unit of the first data transmission controlling device. In detail, a bandwidth of each link line is the same and equal to a predetermined bandwidth (such as 1 megabit/s (M/s)), the link line establishing module compares the bandwidth of each network accessing path and the predetermined bandwidth, and obtains a ratio of the bandwidth of each network accessing path and the predetermined bandwidth. The link line establishing module then divides the each network accessing path to a number of link lines whose number are equal to the ratio, thus to establish a number of link lines on the transmission channel. The link lines can be any combination of actual or virtual link lines.

In block 307, a data receiving module receives data to be transmitted.

In block 309, a data dividing module divides each data packet of the data to be transmitted to a number of sub-packets according to an amount of the link lines of the transmission channel. In the embodiment, an amount of the sub-packets divided from each data packet is equal to the amount of the link lines. In detail, when the data dividing module 15 divides the data packet to the number of sub-packets, the data dividing module 15 adds a unique label to each sub-packets of one of the data packets, and further adds a corresponding sequence number to one of the sub-packets according to a corresponding sequence that the sub-packets located in the data packet.

In block 311, a transmission control module transmits the sub-packets of each data packet to a receiver respectively via the link lines at the same time.

In block 313, a data combination module receives the sub-packets of each data packet, and combine the sub-packets of each data packet to the corresponding data packet in sequence, thus to recover or reconstruct the data to be transmitted. In detail, the data combination module determines which sub-packets belong to the same data packet according to the unique label included in the sub-packets, and combines the sub-packets of the same data packet to the corresponding data packet in sequence according to the sequence number of each sub-packet.

In the embodiment, the method can further include: the data combination module further transmits the recovered data to a target address.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A data transmission controlling device, comprising:
at least one connection port configured to connect to at least one terminal device;
a network connection unit configured to generate a plurality of network accessing paths connecting to another data transmission controlling device in response to a connection and configuration operation of a user;
at least one processing unit, and
a storage unit storing a plurality of modules which are collections of instructions executed by the at least one processing unit, the modules comprising:
a start controlling module configured to control the data transmission controlling device to transmit a conversation request to another data transmission controlling device when receiving a request for starting a conversation aggregation from a user;
a channel establishing module configured to establish a transmission channel between the data transmission controlling device and another data transmission controlling device when another data transmission controlling device accepts the conversation request;
a link line establishing module configured to establish a plurality of link lines on the transmission channel according to each network accessing path of the network connection unit of the data transmission controlling device;
a data receiving module configured to receive data to be transmitted;
a data dividing module configured to divide each data packet of the data to be transmitted to a plurality of sub-packets according to an amount of the link lines of the transmission channel; and
a transmission control module configured to transmit the sub-packets of each data packet to a receiver respectively via the plurality of link lines.

2. The device according to claim 1, wherein a bandwidth of each link line is the same and equal to a predetermined bandwidth, the link line establishing module compares a bandwidth of each network accessing path and the predetermined bandwidth, and obtains a ratio of the bandwidth of each network accessing path and the predetermined bandwidth, and then divides the each network accessing path to a corresponding number of link lines whose number are equal to the ratio, thus to establish the plurality of link lines on the transmission channel.

3. The device according to claim 1, wherein the modules further comprises a data combination module configured to receive the sub-packets of each data packet and combine the sub-packets of each data packet to the corresponding data packet in sequence, thus to recover the data to be transmitted.

4. The device according to claim 3, wherein when the data dividing module divides one of data packets to the plurality of sub-packets, the data dividing module adds a unique label to each sub-packets of the data packets, and further adds a corresponding sequence number to one of the sub-packets according to a corresponding sequence that the sub-packets located in the data packet.

5. The device according to claim 4, wherein when the data combination module receives the sub-packets, the data combination module determines which sub-packets belong to the same data packet according to the unique label included in the sub-packets, and then combines the sub-packets of the same data packet to the corresponding data packet in sequence according to the sequence number of each sub-packet.

6. The device according to claim 3, wherein the data combination module further transmits the recovered data to a target address.

7. A method for controlling data transmission, configured to control data transmission between a first data transmission controlling device and a second data transmission controlling device, comprising:
controlling the first data transmission controlling device to transmit a conversation request to the second data transmission controlling device when receiving a request for starting a conversation aggregation from a user;
establishing a transmission channel between the first data transmission controlling device and the second data transmission controlling device when the second data transmission controlling device accepts the conversation request;
establishing a plurality of link lines on the transmission channel according to each network accessing path generated by a network connection unit of the first data transmission controlling device;
receiving data to be transmitted;
dividing each data packet of the data to be transmitted to a plurality of sub-packets according to an amount of the link lines of the transmission channel; and
transmitting the sub-packets of each data packet to a receiver respectively via the plurality of link lines.

8. The method according to claim 7, wherein a bandwidth of each link line is the same and equal to a predetermined bandwidth, the step of establishing a plurality of link lines on the transmission channel according to each network accessing path generated by a network connection unit of the first data transmission controlling device comprises:
comparing a bandwidth of each network accessing path and the predetermined bandwidth;
obtaining a ratio of the bandwidth of each network accessing path and the predetermined bandwidth; and
dividing each network accessing path to a corresponding number of link lines whose number are equal to the ratio, thus to establish the plurality of link lines on the transmission channel.

9. The method according to claim 7, further comprising:
receiving the sub-packets of each data packet and combining the sub-packets of each data packet to the corresponding data packet in sequence, thus to recover the data to be transmitted.

10. The method according to claim 9, wherein the step of dividing each network accessing path to a corresponding number of link lines whose number are equal to the ratio, thus to establish the plurality of link lines on the transmission channel comprises:
adding a unique label to each sub-packets of the data packets, and a corresponding sequence number to one of the sub-packets according to a corresponding sequence that the sub-packets located in the data packet when dividing one of data packets to the plurality of sub-packets.

11. The method according to claim 10, wherein the step of receiving the sub-packets of each data packet and combining the sub-packets of each data packet to the corresponding data packet in sequence, thus to recover the data to be transmitted comprises:
determining which sub-packets belong to the same data packet according to the unique label included in the sub-packets; and
combining the sub-packets of the same data packet to the corresponding data packet in sequence according to the sequence number of each sub-packet.

12. The method according to claim 9, further comprising:
transmitting the recovered data to a target address.

13. A non-transitory storage medium having stored thereon instructions that, when executed by at least one processor of a computing device, causes the least one processor to execute instructions of a method for automatically testing signal integrity of an electronic product, the method comprising:
controlling the first data transmission controlling device to transmit a conversation request to the second data transmission controlling device when receiving a request for starting a conversation aggregation from a user;
establishing a transmission channel between the first data transmission controlling device and the second data transmission controlling device when the second data transmission controlling device accepts the conversation request;
establishing a plurality of link lines on the transmission channel according to each network accessing path generated by a network connection unit of the first data transmission controlling device;
receiving data to be transmitted;
dividing each data packet of the data to be transmitted to a plurality of sub-packets according to an amount of the link lines of the transmission channel; and
transmitting the sub-packets of each data packet to a receiver respectively via the plurality of link lines.

14. The storage medium according to claim 13, wherein a bandwidth of each link line is the same and equal to a predetermined bandwidth, the step of establishing a plurality of link lines on the transmission channel according to each network accessing path generated by a network connection unit of the first data transmission controlling device comprises:
comparing a bandwidth of each network accessing path and the predetermined bandwidth;
obtaining a ratio of the bandwidth of each network accessing path and the predetermined bandwidth; and
dividing each network accessing path to a corresponding number of link lines whose number are equal to the ratio, thus to establish the plurality of link lines on the transmission channel.

15. The storage medium according to claim 13, further comprising:
receiving the sub-packets of each data packet and combining the sub-packets of each data packet to the corresponding data packet in sequence, thus to recover the data to be transmitted.

16. The storage medium according to claim 15, wherein the step of dividing each network accessing path to a corresponding number of link lines whose number are equal to the ratio, thus to establish the plurality of link lines on the transmission channel comprises:
adding a unique label to each sub-packets of the data packets, and a corresponding sequence number to one of the sub-packets according to a corresponding sequence that the sub-packets located in the data packet when dividing one of data packets to the plurality of sub-packets.

17. The storage medium according to claim 16, wherein the step of receiving the sub-packets of each data packet and combining the sub-packets of each data packet to the corresponding data packet in sequence, thus to recover the data to be transmitted comprises:
determining which sub-packets belong to the same data packet according to the unique label included in the sub-packets; and
combining the sub-packets of the same data packet to the corresponding data packet in sequence according to the sequence number of each sub-packet.

18. The storage medium according to claim 13, further comprising:
transmitting the recovered data to a target address.
